(19) United States
(12) Patent Application Publication
(10) Pub. No.: US 2013/0006761 A1
(43) Pub. Date: Jan. 3, 2013

(54) METHOD, SYSTEM, AND ARTICLE OF MANUFACTURE FOR GENERATING AD GROUPS FOR ON-LINE ADVERTISING

(75) Inventors: Craig Richard Warren, Vancouver (CA); Gerd Juergen Zobel, West Vancouver (CA); Joshua Benjamin Portner, Vancouver (CA); Perry Pak Lin Lo, North Vancouver (CA); David Baocheng Xu, Vancouver (CA)

(73) Assignee: ONE PERSON HEALTH INC., Vancouver, BC (CA)

(21) Appl. No.: 13/518,203

(22) PCT Filed: Dec. 23, 2010
(86) PCT No.: PCT/CA2010/002077

§ 371 Date: Sep. 17, 2012

Related U.S. Application Data
(60) Provisional application No. 61/289,953, filed on Dec. 23, 2009.

(51) Int. Cl. G06Q 30/02

(52) U.S. Cl. 705/14.49

(57) ABSTRACT

An Ad (Advertisement) group for display on a webpage is generated in response to a request for displaying an advertisement on the webpage. Ad units relevant to the content of the webpage are identified with each Ad unit having an associated category. Ad units are selected for insertion into the Ad group. The Ad group has a predefined number of positions that define a time-based sequence for display of the selected Ad units. Each position has associated with it a respective category. Each selected Ad unit is assigned a respective position within the Ad group such that the category associated with the position matches the category associated with the selected Ad unit. The selected Ad units are added to the Ad group in accordance with their respective assigned positions. In certain circumstances additional Ad units may be added to positions within the Ad group that do not have matching categories.

### TECHNICAL FIELD

The present disclosure relates to Internet advertising and more particularly to providing advertisements on webpages.

### BACKGROUND

The Internet has become a very important medium for advertising. One particular method of advertising involves displaying an Ad (Advertisement) in a portion of a display region of the webpage in which the Ad includes a set of Ad units that are displayed sequentially. Each Ad unit contains one or multiple images and information pertaining to a specific advertisement. For this purpose typical Ad servers serve pre-constructed banners (e.g. flash files) that contain the Ad units and send the banners for display when requested. Variations of the banners might be created in advance in order to reflect a different set of ad units within the banner according to advertisement agreements with clients. For example, if a particular variation of an Ad banner needs to be viewed 5,000,000 times within two months, the banner containing the Ad units will be created in advance and stored in the ad server database for display on web pages. When the ad server receives a request, the banner will be selected in accordance to its relevancy to the content of the webpage and its associated priority and scheduling information.

The level of complexity in grouping Ad units to form banners increases dramatically with the number of Ad units. For example, the number of combinations that four Ad units can be arranged in a banner containing four Ad units is 24. The number of combinations of banners that five Ad units can be arranged in groups of 3 to 4 Ad units is 180. The number of combinations of banners that one hundred Ad units can be arranged in groups of 3 to 5 Ad units is 9,222,721,200. It is clear that for prior art methods the level of complexity increases to a point where it is inefficient and impractical, or even impossible, to manage the banners and the number of combinations that are created. This is particularly problematic for clients who would like to advertise their products and/or services or over the Internet but have a large number of products and/or services to be combined in a banner. For example, Sears may want to advertise a banner with multiple products from its catalogue. However, the number of products available is too large for banner combinations to be created and managed using the prior art methods.

### SUMMARY

According to a first broad aspect, a method of generating an Ad (Advertisement) group for display on a webpage having content is provided. The method involves identifying a plurality of Ad units relevant to the content of the webpage in response to receiving a request for displaying an advertisement on the webpage. Each Ad unit includes advertising information and has an associated category. The method involves selecting at least some of the plurality of Ad units for the Ad group. The Ad group has a predefined number of positions. Each position has associated with it a respective category. The positions define a time-based sequence for display of the selected Ad units. The method involves: for each selected Ad unit, assigning the selected Ad unit to a respective position within the Ad group. The respective category associated with the position matches the category associated with the selected Ad unit. This step provides the selected Ad units with respective assigned positions. The method further involves adding the selected Ad units to the Ad group in accordance with their respective assigned positions.

In some embodiments, the method involves filling a position within the Ad group with an additional Ad unit. The category associated with the position is different than the category associated with the additional Ad unit.

In some embodiments, the above filling step involves: selecting the additional Ad unit; assigning the additional Ad units to the position; and adding the additional Ad units to the position.

In some embodiments, the above filling step is performed when there is an insufficient number of selected Ad units having an associated category that is the same as the category associated with the position.

In some embodiments, each position within the Ad group has an associated priority and each Ad unit also has and associated priority. The method involves filling a position within the Ad group with an additional Ad unit, wherein the priority associated with the position is different than the priority associated with the additional Ad unit.

According to a second broad aspect, an Ad server system for providing advertisements is provided. The Ad server system has a processor; a communications interface unit coupled to the processor; and a memory. The memory has a database having a first plurality of Ad units each having advertising information and having an associated category. The database has content information on a plurality of webpages. The memory also has instructions executable by the processor for:
i) responsive to receiving through the communications interface unit a request for displaying an advertisement on a webpage of the plurality of webpages, identifying from the first plurality of Ad units a second plurality of Ad units relevant to the content of the webpage using the content information;
ii) selecting at least some of the second plurality of Ad units for an Ad group that is to be displayed on the webpage, the Ad group having a predefined number of positions defining a time-based sequence for display of the selected Ad units, and each position having associated with it a respective category;
iii) for each selected Ad unit, assigning the selected Ad unit to a respective position of the positions within the Ad group, the respective category associated with the position matching the category associated with the Ad unit; and,
iv) adding the selected Ad units to the Ad group in accordance with their respective assigned positions.

According to a second broad aspect, an article of manufacture is provided. The article of manufacture includes a computer usable medium having computer readable program code means embodied therein for generating an Ad group for display on a webpage having content. The computer readable code means in the article of manufacture includes computer readable code means for identifying a plurality of Ad units relevant to the content of the webpage in response to receiving a request for displaying an advertisement on the webpage. Each Ad unit includes advertising information and has an associated category. The computer readable code means in the article of manufacture includes computer readable code means for selecting at least some of the plurality of Ad units for the Ad group. The Ad group has a predefined number of positions defining a time-based sequence for display of the selected Ad units. Each position has associated with it a respective category. The computer readable code means in the article of manufacture includes computer readable code means for:
for each selected Ad unit, assigning the selected Ad unit to a respective position of the positions within the Ad group, the respective category associated with the position matching the category associated with the selected Ad unit.

The computer readable code means in the article of manufacture also includes computer readable code means for adding the selected Ad units to the Ad group in accordance with their respective assigned positions.

### BRIEF DESCRIPTION OF THE DRAWINGS

The features and advantages will become more apparent from the following detailed description of the preferred embodiment(s) with reference to the attached figures, wherein:

FIG. 1 is a flow chart of a method of creating Ad (Advertisement) groups containing Ad units with each Ad unit containing advertising information for display, in accordance with a preferred embodiment;

FIG. 2 is a block diagram of an Ad server system for implementing the method of FIG. 1;

FIG. 3A is a block diagram of an exemplary Ad group created using the method of FIG. 1;

FIG. 3B an exemplary display of one Ad unit in the Ad group of FIG. 3A;

FIG. 4 is block diagram showing the arrangement Ad units which are stored in a database of the Ad server system of FIG. 2;

FIG. 5 is a block diagram of an Ad group template illustrating assignment of categories within the Ad group template for display;

FIG. 6 is a flow chart of an exemplary method implemented by the Ad server system of FIG. 2 for selecting Ad units for an Ad group;

FIG. 7A is a block diagram of an exemplary Ad group template for use in a first exemplary business scenario;

FIG. 7B is a block diagram of another exemplary Ad group template for use in a second exemplary business scenario;

FIG. 8 is a block diagram of yet another exemplary Ad group template; and,

FIG. 9 is a flow chart of a method of assigning Ad units to positions within an Ad group, in accordance with another embodiment.

It is noted that in the attached figures, like features bear similar labels.

### DETAILED DESCRIPTION OF THE PREFERRED EMBODIMENTS

Methods of providing advertising information over the Internet include providing advertising information in the form of Ad groups each containing a number of Ad (Advertisement) units. The Ad units within an Ad group each include information on a product or service for example and are displayed sequentially in time on a webpage visited by a user. Prior Art methods are limited in that the management of the Ad groups becomes increasingly complex with increasing number of Ad units to advertise and increasing number of Ad units per Ad group. Particularly, as discussed in the Background section the Ad groups contain a number of Ad units. In some prior art methods Ad groups are pre-defined prior to any users visit the websites that are to display the Ad groups. The management of these Ad groups become impractical or even impossible when the number of Ad units is as low as 100.

This section discloses embodiments in which Ad groups are created dynamically in response to request for advertising information. This method of providing Ad groups provides a simplification in that pre-defined Ad groups need not be managed. Instead, they are created on-the-fly as needed and as a result there is no need for management and creation of pre-defined Ad groups. Furthermore, the methods and systems disclosed provide a novel way of identifying Ad units based on relevancy of the Ad units to content of the webpages displaying the Ad units and based on performance of the Ad units. Furthermore, the disclosed methods of assigning identified Ad units to Ad groups involve Ad group and Ad unit templates that are customizable for individual clients' needs. The Ad group templates define different categories of Ad units to include within Ad groups, and in some cases are used to maximize the number of categories while minimizing the number on Ad units from the same category.

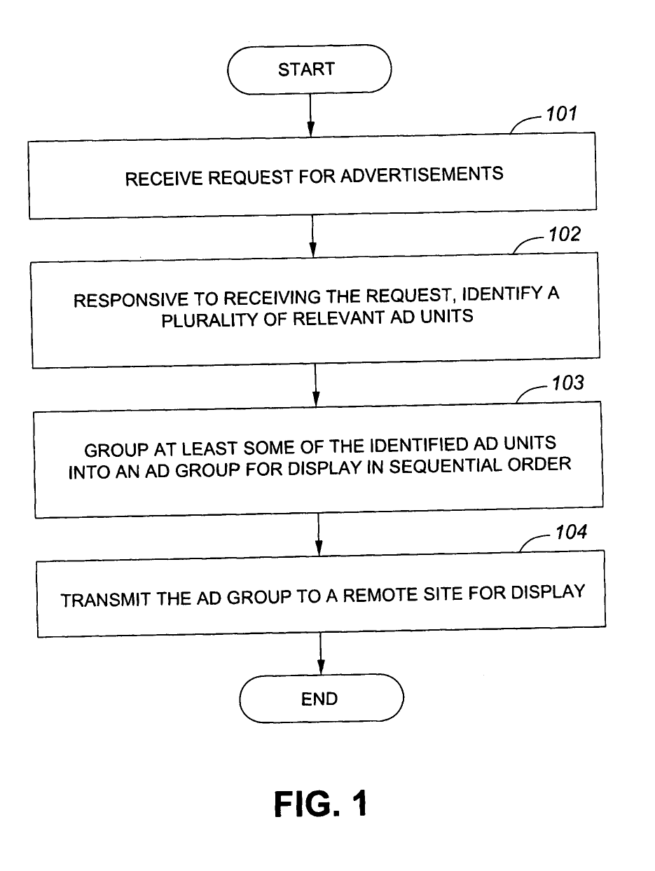

Referring to FIG. 1, shown is a flow chart of a method of creating Ad groups containing Ad units with each Ad unit containing advertising information for display, in accordance with a first embodiment. At step 101, a request for advertisements is received. The request is sent in response to a user visiting a webpage for example. At step 102, in response to receiving the request a plurality of Ad units relevant to the content of the webpage are identified. Each Ad unit contains advertising information. The advertising information includes information on products and/or services, for example. At step 103, the identified Ad units are grouped into an Ad group for display in sequential order. At step 104 the Ad group is transmitted to a remote site for display.

In some implementations the number of Ad units to be placed within an Ad group is pre-defined and in some cases the number of Ad units identified may be greater than the pre-defined number of Ad units to be placed into the Ad group. In such cases, the step 102 involves selecting only some of the identified Ad units for grouping in the Ad group. The selection process will be described in further detail below.

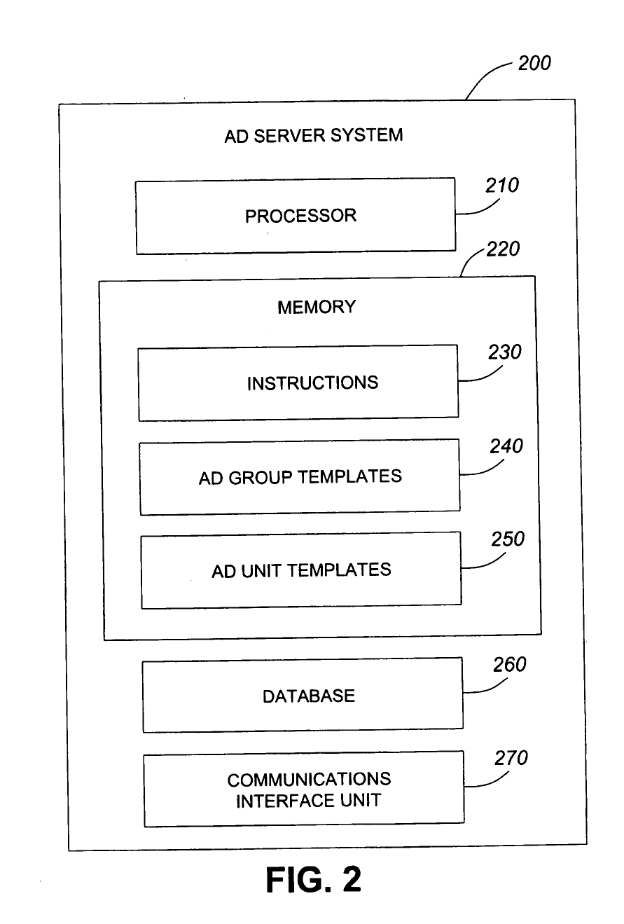

Referring to FIG. 2, shown is a block diagram of an Ad server system 200 for implementing the method of FIG. 1. The Ad server system 200 has a processor 210, a memory 220, a database 260, and a communications interface unit 270. The memory 220 includes instructions 230 for execution by the processor 210, Ad group templates 240, and Ad unit templates 250.

The communications interface unit 170 provides interfacing functionality between the processor 210 of the Ad server system 200 and other computing systems (not shown) at remote sites and which are capable of wireless and/or wire communications. The communications interface unit 270 receives requests for advertisements and transmits the requests to the processor 210. The communications interface unit 270 also receives Ad groups from the processor 210 and transmits the Ad groups to the remote sites.

The instructions 230 include instructions for the processor to create Ad groups and send Ad groups in response to requests for advertisements having specific attributes, in accordance with the method of FIG. 1 described above. The instructions 230 also include instructions for implementing additional methods that are described below.

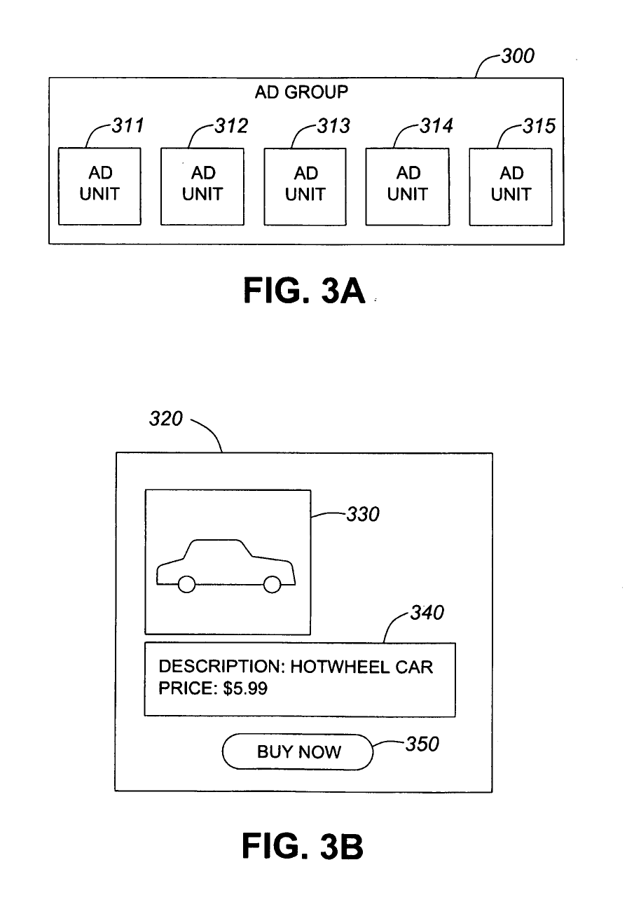

As discussed above, the memory 220 also includes Ad group templates 240 and Ad unit templates 250. The Ad groups each contain a plurality of Ad units for display in a sequential order. An exemplary Ad group 300 is shown in FIG. 3A. The Ad group has five Ad units 311, 312, 313, 314, 315. However, it is clear that implementations are not limited to five Ad units. More generally, an Ad group includes two or more Ad units. The Ad units 311, 312, 313, 314, 315 are included in the Ad group 300 for display in sequential order as advertisements. FIG. 3B shows an exemplary display 320 of one of the Ad units 311, 312, 313, 314, 315 of FIG. 1. The display 320 includes an image 330 of a product being sold, a description 340 of the product and price, and an icon 350 for linking to a webpage for purchasing the product. In this embodiment each Ad unit 311, 312, 313, 314, 315 of Ad group 300 is displayed having a format similar to that of Ad unit 320, and for this purpose the Ad group templates 250 contain information on the presentation of the respective Ad groups 250. The information includes the number of Ad units within an Ad group, information on the format and style to use, and information on transition effects to use during transition of display from one Ad unit to another. In some implementations, a particular Ad template is customized for a particular client's needs and used to display Ad groups for the client.

Referring back to FIG. 2, each one of the Ad unit templates 250 defines which asset or assets are to be used when creating Ad units. Assets are areas of interest within an Ad unit. They are typically represented by clickable images and logos, text-links, link-buttons, action buttons such as Zoom and Audio on/off, input-fields, forms, and link-maps. Engagement points can trigger an event such as opening a new browser window, opening an internal pop-up, clicking through to a another web page, turning on/off sound and music, and starting and controlling a video, for example. Each one of the Ad unit templates 250 also defines the layout of the assets to be used within Ad units.

Ad unit templates and Ad group templates are also used to define a presentation format and create a branding identity. As discussed above, an Ad unit template defines which assets are to be used in creating Ad units. Add units created from the same Ad unit template need not have the identical format or identical assets. For example two Ad units created from the same Ad unit template may require different assets and therefore will have different assets. The Ad unit template also defines the location where the assets are to appear in Ad units and defines what style is to be used. In addition, the Ad unit template defines the position and the dimensions (width and height and layer) of the assets to be presented. Furthermore, the Ad unit template defines placeholders/area for specific functionality pertaining to a user experience. For example, the specific functionality might include a store locator where an input form for entering a ZIP Code is provided and wherein responsive to submission of ZIP code information a map is shown within the Ad unit.

An Ad group template defines the width and height of the Ad units within the Ad group and what Ad units may be grouped into the Ad groups that are created using the Ad group template. In addition, an Ad group template defines: i) the order in which Ad units are displayed and the duration of display of each Ad unit; ii) the maximum number of Ad units to display; iii) visual transition effects to be used between displays of Ad units; and, client-side functionality that applies to Ad units. Again, client-side functionality might include a store locator for example.

There are a number of possible formats for Ad groups. In some implementations an Ad group is html-based. However, in some implementations the Ad group includes Ad units which include an image and an image map for overlay over the respective image. In such implementations, for each Ad unit image and the image map are generated using advertising information on assets specific to the Ad unit and predefined rules or attributes on how to present the assets. As discussed above the rules or attributes are defined in an Ad unit template. These attributes are used, together with advertising information specific to the Ad unit, to generate the image and the image map. For example, with reference to FIG. 3B, the advertising information includes, for example, information on the following assets: the image 330, the description 340, and the icon 350. Regarding the icon 350, the information includes a link to another website, for example. The attributes in the Ad unit template define, among other possible features, the size and location of the image 330 and the description 340. The attributes are used to assemble assets such as the image 330 and the description 340 to generate an image for the Ad unit. Furthermore, the attributes and the advertising information associated with the particular Ad unit are used to generate the image map for overlaying over the image generated for the Ad unit. For example, with reference to FIG. 3B, the attributes in the Ad template and the advertising information are used to generate an image map for overlaying the icon 350.

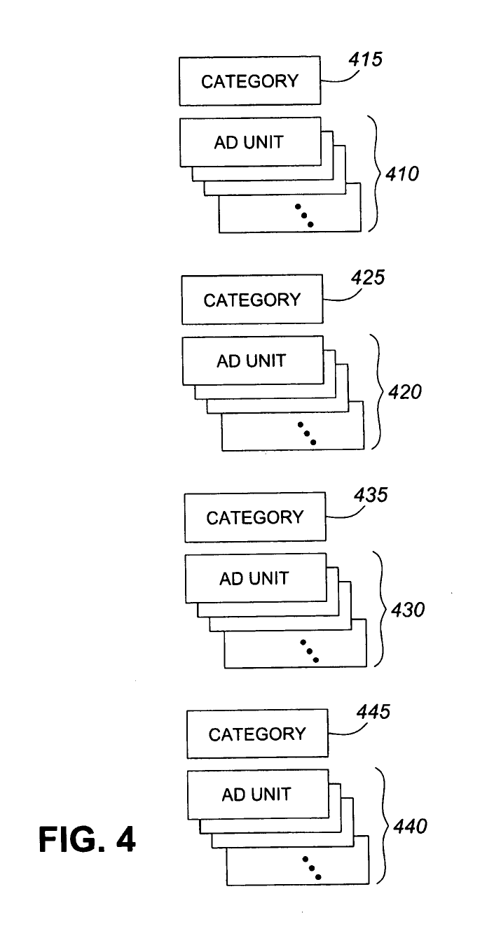

The database 260 includes Ad units (not shown) arranged in categories. A block diagram showing the arrangement of the Ad units is shown in FIG. 4. A first set of Ad units 410 is classified under a first category 415. A second set of Ad units 420 is classified under a second category 425. A third set of Ad units 430 is classified in a third category 435. A fourth set of Ad units 440 is classified in a third category 445. The sets of ad units 410, 420, 430, 440 collectively represent for example Ad units of a particular client requiring advertisement. For example, the client may be Sears and the first, second, third and fourth categories 415, 425, 435, 445 might represent winter, spring, summer, and fall apparels. The first, second, third, and fourth categories 415, 425, 435, 445 can represent any suitable category. For example, in some case there may be three categories corresponding to high, medium, and low priorities for advertising. Other categories include, product, service, and introductory advertisement, for example. Each Ad unit in the sets of ad units 410, 420, 430, 440 is assigned a respective category identifier. In some instances a positions within an Ad group might be associated with category that is a combination of two categories. For example, such a category might be a combination winter/spring category.

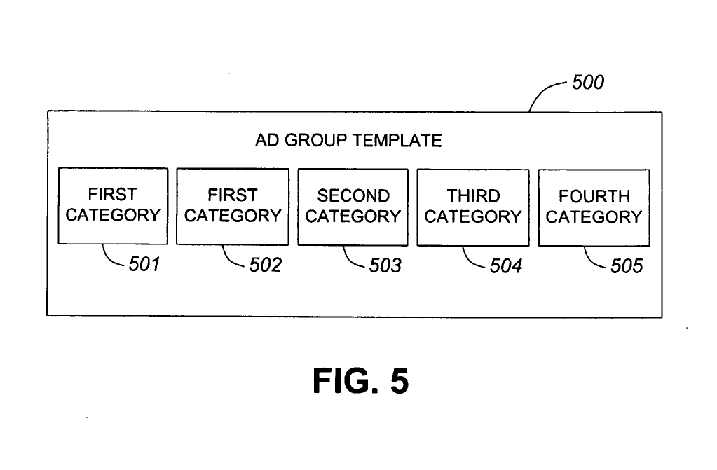

The assignment of categories 415, 425, 435, 445 is used in the selection of Ad units and for determining the position of the Ad units within an Ad group. For example, shown in FIG. 5 is a block diagram of an Ad group template 500 illustrating assignment of categories within the Ad group template 500 for display. The illustration of Ad group template 500 shows that Ad units from the first category 410 are to be placed in first and second positions 501, 502, Ad units from the second category 420 are to be placed in a third position 503, Ad units from the third category 430 are to be placed in a fourth position 504, and Ad units from the fourth category 440 are to be placed in a fifth position 505. The positions 501, 502, 503, 504, 505 represent the order in which Ad units will be displayed. More particular, the sequence of Ad units being displayed in the order of the positions 501, 502, 503, 504, 505 with an Ad unit in position 501 being displayed first and an Ad unit in position 505 being displayed last. The arrangement of categories shown in the template 500 is shown for illustrative purposes only, and the person of skill in the art will recognize that there are a number of different combinations in which to arrange the categories 415, 425, 435, 445, or any suitable sub-combination thereof, in the template 500.

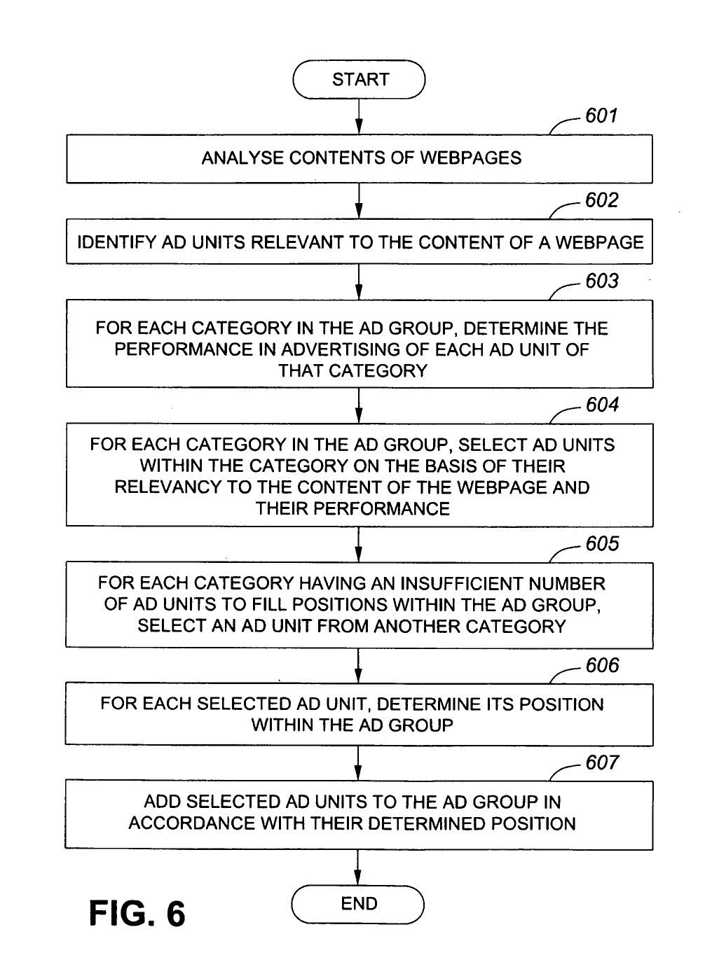

Referring to FIG. 6, shown is a flow chart of an exemplary method implemented by the Ad server system 200 of FIG. 2 for selecting Ad units for an Ad group. In this method Ad units are selected on the basis of the contents of the web pages that are to display the Ad units. More specifically, the content of a webpage is used to select appropriate Ad units for display on the webpage. This requires an analysis of the content of the webpage. As such, at step 601 the contents of webpages are analyzed to provide content information. At step 602, in response to receiving a request for advertising information from a particular webpage Ad units are identified based on the relevancy of the Ad units to the content of the webpage. As discussed above an Ad group template may include more than one category of Ad units for display. At step 603, for each category in the Ad group the performance in advertising of each Ad unit of that category is determined. At step 604, for each category in the Ad group Ad units within the category are selected on the basis of their relevancy to the contents of the webpage and their performance. A step 605, for each category having an insufficient number of Ad units to fill respective positions in the Ad group an Ad unit from another Ad group is selected. At step 606, the position of each selected Ad unit within the Ad group is determined. At step 607, the selected Ad units are added to the Ad group in accordance with their determined position.

The method of FIG. 6 will now be described in further details.

Regarding step 601, the webpages are analyzed to identify relevant terms used in the webpages and associate with them respective weights to produce a term vector. The webpages can be obtained by crawling publishers' websites, for example. The weights provide information on the relevancy of the terms in the context of a webpage. They are determined on the basis of the number of times they appears in the webpage and the location within the web page, for example. It is to be made clear that it is only one exemplary way to perform content analysis and that there are other well-known ways to perform such an analysis. Once a term vector is obtained, the vector undergoes a well-known normalization process to ensure the length of the vector is 1. With reference to FIG. 2, the term vectors are stored in the database 260 for later use.

Regarding step 602, relevancy is determined by matching the term vector of the webpage with term vectors or tag vectors of Ad units. More specifically, each Ad unit includes terms or tags associated with it, and each term has associated with it a respective weight. For example, an Ad unit directed to men's pants may have the following terms associated with it: clothing, men, and pants. In some implementations the terms associated with a particular Ad unit are given equal weightings.

The term vector of the webpage is matched to the term vectors of the Ad units using a well-known algorithm which calculates for each Ad unit the dot product of the term vector of the webpage and the term vector of the Ad unit. The dot product provides a measure of the relevancy of the Ad unit to the webpage content. For example, the value of the dot product may range from 0 to 1 with 0 indicating that the Ad unit is not relevant to the content of the webpage and 1 indicating that the Ad unit is highly relevant to the content of the webpage. An Ad unit is considered a match to the content of the webpage when the dot product exceeds a pre-defined minimum threshold value.

Regarding step 603, as discussed above for each category in the Ad group the performance in advertising of each Ad unit of that category is determined. The performance can be evaluated in a number of ways. However, a useful parameter for evaluating performance is the click through rate which is given by:

$$click through rate = \frac{No . of clicks}{No . of Impressions} * 100 \%$$

where the No. of Impressions corresponds to the number of times an Ad units was displayed and the No. of clicks corresponds to the number of times the Ad unit was selected.

In this exemplary implementation the performance is evaluated using one of a number of different levels. At a first level the overall performance of an Ad unit is calculated where the click through rate is calculated for all impressions of the Ad unit. At a second level the performance of the Ad unit is evaluated in the context of the webpage. More specifically, the click-through rate is calculated using only the No. impressions on that specific webpage and the No. of clicks of the Ad unit units on the webpage. At a third level the performance is evaluated by calculating the click through rate for individual terms/tags within Ad units. At a fourth level the performance of the Ad unit is evaluated in the context of the webpage and for each position within the Ad group template. More specifically, for each position within the template the click through rate is calculated using only the No. impressions on that specific webpage at the position within the template and the No. of clicks of the Ad unit on the webpage when displayed at the position within the template.

As discussed above one of the performance levels is used in assessing the performance of the Ad units. The selection of which level is to be used depends on the availability of statistical information. The granularity of the click through rate decreases with increase in the level of performance. It is therefore preferable to use the highest possible performance level. However, the evaluation of the click through rate requires maintaining a statistical sample of the Nos. of impressions and Nos. clicks down to a fine granularity as low as on a per webpage basis and a per position within a template basis. The statistical sample may be too small to provide reliable statistics on the performance. As such, the highest performance level that provides accurate statistical information for calculating the click through rate is therefore selected for assessing the performance of the Ad units. For each Ad unit the click through rate provides a performance score. The performance score need not be bases on the click through rate and other measures of performance revenue per click, for example, can be used. For example, in some implementations a combination of a click through rate and revenue per click is used to establish a performance score that that can be normalized to values between 0 and 1. Such, methods are well-known in the art.

In some instances the statistical sample is too small to provide accurate statistical information even the lowest performance level. In such instances the Ad units are given equal performance scores until the statistical sample is large enough to provide reliable statistics.

Referring back to FIG. 6, at step 604 for each category in the Ad group Ad units within the category are selected on the basis of their relevancy to the contents of the webpage and their performance. More specifically, an overall score of Ad units is calculated using the level of relevancy of the Ad units to the webpage obtained at step 602 and the performance scores obtained at step 603. For example, for a particular Ad units the overall score is given by

overall score=relevancy*performance score.

The Table I below provides the relevancy of each term/tag associated with an Ad unit on a diabetes monitoring kit. The relevancy of the terms is determined based on the content of a webpage on diabetes.

TABLE I
Relevancy of terms/tags associated with an Ad unit on
a diabetes monitoring kit. Relevancy is determined with
respect to a webpage on diabetes.

| Terms/Tags | Relevancy |
|---|---|
| Diabetes | 0.9 |
| Blood | 0.7 |
| Insulin | 0.5 |
| Sugar | 0.4 |
| Chronic | 0.1 |
| Wound Care | 0.1 |

Table II below provides the performance scores and overall scores for the most relevant terms of the Ad unit of Table I.

TABLE II
The relevancy of the terms is determined with respect to
a webpage on diabetes.
Ad Unit (Diabetes Monitoring Kit)

| Terms/Tags | Performance score | Overall Score |
|---|---|---|
| Diabetes | 0.6 | 0.6 * 0.9 = 0.54 |
| Blood | 0.2 | 0.2 * 0.7 = 0.14 |
| Insulin | 0.9 | 0.9 * 0.5 = 0.45 |

Regarding step 605, there are number of ways in which the selection of Ad units can be made. For example in some implementations the selection is based on the relevancy of the Ad units to the content of the webpage and their performance. In some implementations, step 605 is not performed and empty positions within an Ad group are not filled with Ad units. Step 605 provides a way to fill available positions within the Ad group which would otherwise not be filled because of a lack of Ad units within the category associated with the position. However, in some business scenarios it may be preferable to not fill those positions. As such, in some implementations prior to filling a position with an Ad unit from another category a determination of whether the position is allowed to be assigned an Ad unit of another category is made. This is done, for example, using flags associated with respective positions each indicating whether the position can be filled with Ad unit associated with category that is different that the category assigned to the position. These flags can be set in the Ad group template used to create the Ad group.

Regarding step 606, there are a number of ways in which the selected Ad units can be positioned within the Ad group. With reference back to FIG. 5, in some implementations each position 501, 502, 503, 504, 505 has assigned to it an associated category. For example, two selected Ad units within the first category are placed in positions 501, 502. In some implementations the order in which the two Ad units are placed in positions 501, 502 is determined using a random process in which the two Ad units are shuffled to provide a random ordering.

A particular Ad unit may perform best in a particular position. As such, in some implementations the ordering process involves using the above described random process to shuffle Ad units within categories and provide a random ordering. This ordered process is used for a period of time to allow the Ad units to be placed in different positions. During that time the performance of the Ad units as function of position within the Ad group is monitored to collect statistical information for rating the performance at each position. After sufficient information is collected to provide a reliable statistical analysis, the performance of each position within the Ad group is determined using the statistical information collected. The position of Ad units within a category is then determined on the basis of the overall performance of the Ad units and the performance of the positions with the Ad group. For example referring back to FIG. 5, position 501 may have associated with it a higher performance than position 502 and a first Ad unit may be placed in position 501 while a second Ad Unit having a lower overall performance than that of the first Ad unit may be placed in positions 502.

As discussed above, statistical information is collected for an initial period of time before assigning positions within the Ad group on the basis the overall performance of the Ad units and the performance of the positions with the Ad group. In some implementations monitoring of the performance of the add units as a function of position within the Ad group is continued after the initial period of time in order to collect additional statistical information.

The method of FIG. 6 provides an exemplary method of populating an Ad group with Ad units. However, some business scenarios may require more sophisticated mechanisms for assigning Ad units to Ad groups. The following examples show additional ways to assign Ad units to an Ad group.

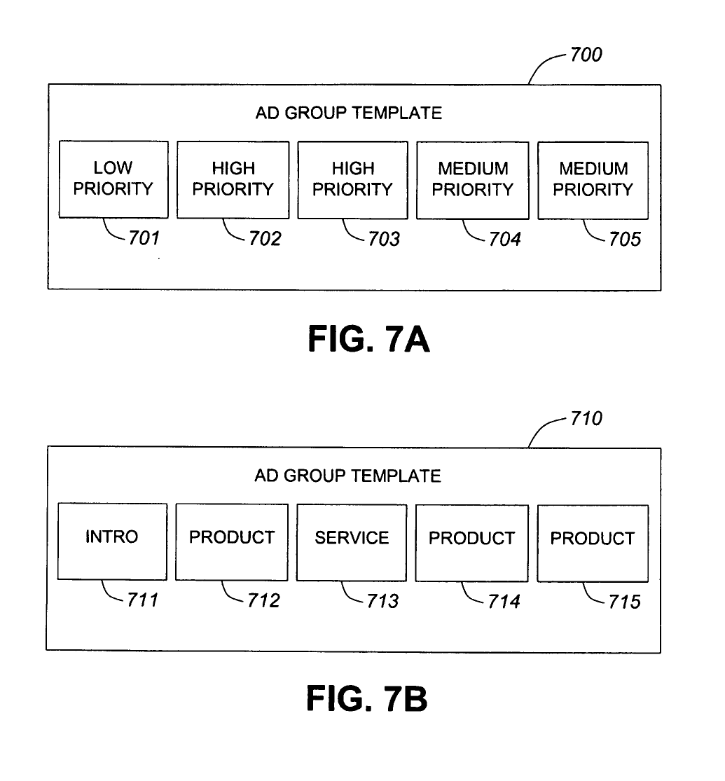

With reference to FIG. 7A, an Ad group template 700 is used in a first business scenario. In this scenario, Ad units are categorized into High, Medium and Low Priorities. More particularly, each Ad unit is assigned one of the three priorities. The Ad group template 700 has five positions 701, 702, 703, 704, 705. Position 701 has a low priority associated with it. Positions 702, 703 have a have a high priority associated with them, and positions 704, 705 have a medium priority associated with them.

In a first case, seven Ad units are identified as being relevant to the content of a webpage and as having a required performance. The Ad units are shown in Table III below as all being associated with products assigned with a high priority.

TABLE III
Listing of Ad units identified as candidates for selection for
an Ad Group for a first case of a first business scenario.
Scenario 1 - Case 1: Ad units identified

| | |
|---|---|
| Ad unit 1 (Product A) | Priority High |
| Ad unit 2 (Product B) | Priority High |
| Ad unit 3 (Product C) | Priority High |
| Ad unit 4 (Product D) | Priority High |
| Ad unit 5 (Product E) | Priority High |
| Ad unit 6 (Product F) | Priority High |
| Ad unit 7 (Product G) | Priority High |

In this case two Ad units are selected for the high priority positions 702, 703. No Ad unit having medium or low priority has been identified. As such, three other high priority Ad units are selected for positions 701, 704, 705.

In a second case, seven Ad units are identified as being relevant to the content of a webpage and as having a required performance. The Ad units are shown in Table IV below as being associated a product assigned with either a high or medium priority.

TABLE IV
Listing of Ad units identified as candidates for selection for
an Ad group for a second case of a first business scenario.
Scenario 1 - Case 2: Ad units identified

| | |
|---|---|
| Ad unit 1 (Product A) | Priority High |
| Ad unit 2 (Product B) | Priority High |
| Ad unit 3 (Product C) | Priority High |
| Ad unit 4 (Product D) | Priority High |
| Ad unit 5 (Product E) | Priority Medium |
| Ad unit 6 (Product F) | Priority Medium |
| Ad unit 7 (Product G) | Priority Medium |

In this case two Ad units are selected from Ad units 1, 2, 3, 4 and assigned to positions 702, 703, 704, 705. One product is selected from products E, F, G for position 701.

In a third case, seven Ad units are identified as being relevant to the content of a webpage and as having a required performance. The Ad units are shown in Table V below as being associated with products with either a high or medium priority.

TABLE V
Listing of Ad units identified as candidates for selection for
an Ad group for a third case of a first business scenario.
Scenario 1 - Case 3: Ad units identified

| | |
|---|---|
| Ad unit 1 (Product A) | Priority High |
| Ad unit 2 (Product B) | Priority Medium |
| Ad unit 3 (Product C) | Priority Medium |
| Ad unit 4 (Product D) | Priority Medium |
| Ad unit 5 (Product E) | Priority Medium |
| Ad unit 6 (Product F) | Priority Medium |
| Ad unit 7 (Product G) | Priority Medium |

In this case Ad unit 1 is selected and assigned to position 702. In addition, four Ad units are selected from Ad units 2, 3, 4, 5, 6, 7 and assigned to positions 702, 703, 704, 705.

In a fourth case, seven Ad units are identified as being relevant to the content of a webpage and as having a required performance. The Ad units are shown in Table VI below as having either a high or medium priority.

TABLE VI
Listing of Ad units identified as candidates for selection for
an Ad group for a third case of a first business scenario.
Scenario 1 - Case 4: Ad units identified

| | |
|---|---|
| Ad unit 1 (Product A) | Priority High |
| Ad unit 2 (Product B) | Priority High |
| Ad unit 3 (Product C) | Priority High |
| Ad unit 4 (Product D) | Priority Medium |
| Ad unit 5 (Product E) | Priority Medium |
| Ad unit 6 (Product F) | Priority Medium |
| Ad unit 7 (Product G) | Priority Medium |

In this case, Ad units 1, 2, 3 are selected, together with one of Ad units 4, 5, 6, 7 and assigned to positions 702, 703, 704. Two Ad units are selected from remaining ones of Ad units 4, 5, 6, 7 and assigned to positions 701, 705.

With reference to FIG. 7B, an Ad group template 710 is used in a second business scenario. In this scenario, Ad units are categorized into introduction, product, and service categories. In this scenario an advertiser wants introductory information to be presented before specific products and services are advertised. Each Ad unit is assigned one of the three priorities. The Ad group template 710 has five positions 711, 712, 713, 714, 715. Position 711 has the category “introduction” associated with it. Positions 702, 704, 705 have the category “Product” associated with them, and positions 703 have the category “Service” associated with it.

In a first case, twelve Ad units are identified as being relevant to the content of a webpage and as having a required performance. The products are shown in Table VII below as being in one of the three categories. In this implementation a priority is associated with each category. More particularly, a numeric value is associated with each category. Priority 7 is used to identify Ad units advertising products, priority 8 is used to identify Ad units advertising services, and priority 9 is used to identify Ad units that provide introductions to advertisements.

TABLE VII
Listing of Ad units identified as candidates for selection for
an Ad group for a first case of a second business scenario.
Scenario 2 - Case 1: Ad units identified

| | |
|---|---|
| Ad unit 1 (Product A) | Priority 7 (Product) |
| Ad unit 2 (Product B) | Priority 7 (Product) |
| Ad unit 3 (Product C) | Priority 7 (Product) |
| Ad unit 4 (Product D) | Priority 7 (Product) |
| Ad unit 5 (Product E) | Priority 7 (Product) |
| Ad unit 6 (Product F) | Priority 7 (Product) |
| Ad unit 7 (Service G) | Priority 8 (Service) |
| Ad unit 8 (Service H) | Priority 8 (Service) |
| Ad unit 9 (Service I) | Priority 8 (Service) |
| Ad unit 10 (Service J) | Priority 8 (Service) |
| Ad unit 11 (Introduction K) | Priority 9 (Introduction) |
| Ad unit 12 (Introduction L) | Priority 9 (Introduction) |

In a second case, twelve Ad units are identified as being relevant to the content of a webpage and as having a required performance. The Ad units are shown in Table VIII below as all being in the product category identified by priority 7.

TABLE VIII
Listing of Ad units identified as candidates for selection for
an Ad group for a second case of a second business scenario.
Scenario 2 - Case 2: Ad units identified

| | |
|---|---|
| Ad unit 1 (Product A) | Priority 7 (Product) |
| Ad unit 2 (Product B) | Priority 7 (Product) |
| Ad unit 3 (Product C) | Priority 7 (Product) |
| Ad unit 4 (Product D) | Priority 7 (Product) |
| Ad unit 5 (Product E) | Priority 7 (Product) |
| Ad unit 6 (Product F) | Priority 7 (Product) |
| Ad unit 7 (Product G) | Priority 7 (Product) |
| Ad unit 8 (Product H) | Priority 7 (Product) |
| Ad unit 9 (Product I) | Priority 7 (Product) |
| Ad unit 10 (Product J) | Priority 7 (Product) |
| Ad unit 11 (Product K) | Priority 7 (Product) |
| Ad unit 12 (Product L) | Priority 7 (Product) |

In this case three of Ad units 1, 2, 3, 4, 5, 6, 7, 8, 9, 10, 11, 12 are selected for positions 712, 714, 715. In this case there are no Ad units specific to the introduction and service categories for assignment to positions 701, 703. As such, two ad units are selected from the remaining Ad units and assigned to positions 711, 713.

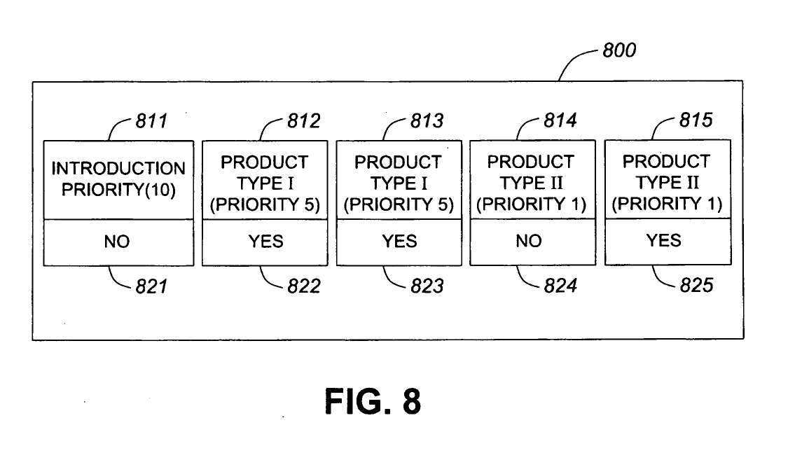

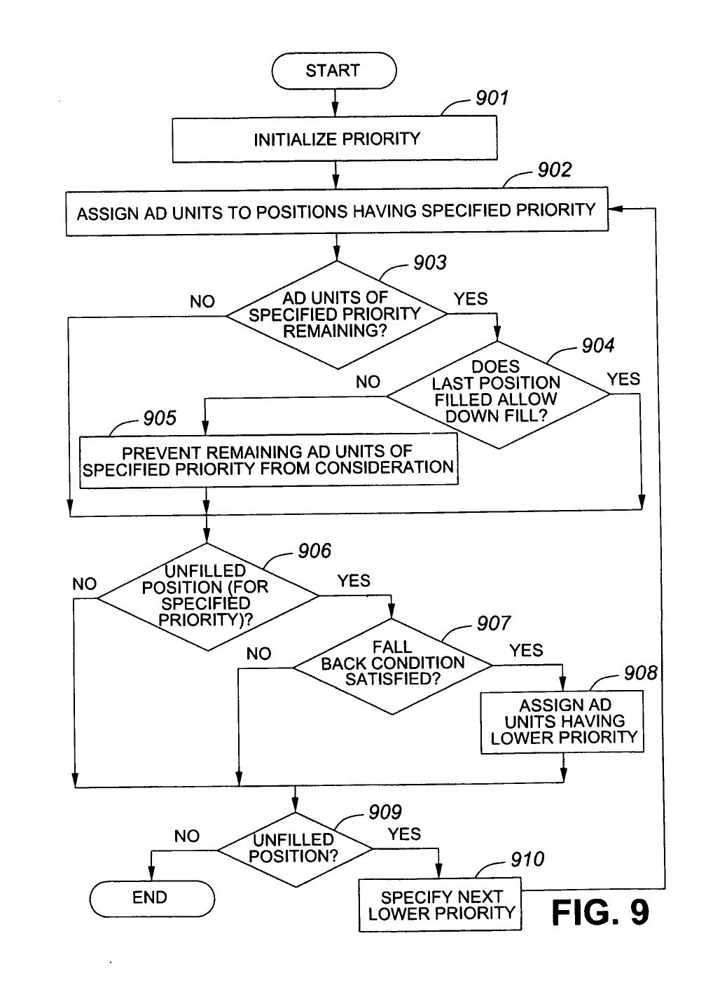

The above two business scenarios illustrate the need for a sophisticated mechanism for assigning Ad units to positions within Ad groups. More particularly, in the first business scenario if there is no Ad unit to fill positions within a particular category Ad units from other categories are assigned to the positions. Furthermore, in the first business scenario priority is given to Ad units having higher priority over those with lower priority when assigning Ad units to positions. However, in the second business scenario there is no priority given to Ad units having a higher priority over those with lower priority when assigning Ad units to positions. As such, while in some cases it is preferable to prioritize the assignment of Ad units and allow Ad units to be assigned across categories, in other cases it is preferable to limit assignment of Ad units to positions in Ad groups having their respective categories. A method of assigning Ad units to positions within Ad groups will now be described with reference to FIGS. 8 and 9.

In FIG. 8, shown is a block diagram of an exemplary Ad group template 800. The template has five positions 811, 812, 813, 814, 815. Position 811 is assigned “Introduction” as a category. Positions 812, 813 are assigned a “Product—Type I” category, and positions 814, 815 are assigned a “Product—Type II” category. Each category is represented by a priority identifier. More particularly, the “Introduction” category is identified a priority 10, the “Product—Type I” category is identified as priority 5, and the “Products—Type II” category is identified as priority 1. Positions 811, 812, 813, 814, 815 have flags 821, 822, 823, 824, 825, respectively associated with them. As will be discussed in further detail below the flags 821, 822, 823, 824, 825 are used indicated how Ad units are to be assigned to the positions 811, 812, 813, 814, 815.

Referring to FIG. 9, shown is a flow chart of a method of assigning Ad units to positions within an Ad group, in accordance with another embodiment. The method is applied using a list of Ad units that have been selected as candidates for display on a particular webpage. An example of such a list is shown in Table IX. The list includes Ad units selected as candidates for insertions into an Ad group that is being created using the Ad group template 800 of FIG. 8.

TABLE IX
List of candidate Ad units for insertion into an Ad group.

| Ad unit | Category | Priority | Assigned |
|---|---|---|---|
| Ad Unit 1 | Introduction | 10 | Yes |
| Ad Unit 5 | Introduction | 10 | No |
| Ad Unit 6 | Introduction | 10 | No |
| Ad Unit 2 | Product - Type I | 5 | Yes |
| Ad Unit 7 | Product - Type I | 5 | Yes |
| Ad Unit 4 | Product - Type I | 5 | Yes |
| Ad Unit 3 | Product - Type I | 5 | No |
| Ad Unit 8 | Product - Type I | 5 | No |
| Ad Unit 11 | Product - Type I | 5 | No |
| Ad Unit 13 | Product - Type I | 5 | No |
| Ad Unit 9 | Product - Type I | 5 | No |
| Ad Unit 12 | Product - Type II | 1 | Yes |

The Ad units in the list of Table IX have been sorted into categories or priorities. Furthermore, for each category the ad units within the category have been randomly shuffled to provide a random ordering of the Ad units. The sorting of the Ad units into categories provides a useful arrangement for implementing the method of FIG. 9. However, it is to be made clear that the method of FIG. 9 does not require this type of sorting. The random shuffling prevents the same Ad units from being repeatedly selected for insertion into the Ad group. However, as discussed above there are other methods of selecting Ad units within a category.

At step 901, a priority corresponding to the highest priority of an Ad group being populated with Ad units is specified. For example, with reference to FIG. 8, the highest priority within an Ad group created using the Ad group template 800 is priority 10. At step 902, Ad units within the list of candidate Ad units and having the specified priority are assigned to positions within the Ad group having the specified priority. With reference to FIG. 8 and Table IX, position 811 is the only position with priority 10 in the Ag group. As such, in this example only one of Ad units 1, 5, and 6 will be assigned. The assignment involves selecting the first Ad unit of priority 10 in the list, which happens to be Ad unit 1, and associating it with position 811. Alternatively, any one of the first three Ad units 1, 5, 6 can be randomly selected.

At step 903, if there are Ad units of the specified priority that have not been assigned then step 904 is performed; otherwise with step 906 is performed. For example in the list of Table IX only one of the Ad units 1, 5, 6 with priority 10 is being assigned since the Ad group template 800 defines only one position with priority 10. At step 904, if a flag associated with the last position that has been assigned an Ad unit indicates that further assignment of Ad units of the specified priority is not allowed then at step 905 the remaining Ad units having the specified (or a higher) priority which have not been selected are prevented from further consideration; otherwise step 906 is performed. For example, the Ad units 5 and 6 are not selected and are removed from the list. Alternatively, the Ad units 5 and 6 are tagged as being not available for consideration.

At step 906, if there are unfilled positions within the Ad group that have associated with them the specified (or a higher) priority then step 907 is performed; otherwise step 909 is performed. For example, in the Ad group 800 the position 811 of priority 10 is filled with Ad unit 1 and there are no other positions of priority 10 to be filled. However, in some cases a list similar to that of Table IX may not have Ad units of priority 10. In that case position 811 would be left unfilled at step 906.

At step 907, if a fall back condition is satisfied then at step 908 Ad units from the list having a lower priority than the specified priority are assigned to the unfilled positions having the specified priority. This allows the positions to be filled even if there are not enough Ad units to fill all available positions having the specified priority. The fall back condition might be a condition where if less than two Ad units having the specified priority have been assigned a position then the method proceeds with selecting an Ad unit of a lower priority, for example. Alternatively, in some implementations each position within the A group has associated with it a flag that indicates whether or not the position can be filled with an Ad unit of another priority in the event that there are no other available Ad units.

Regarding step 908, there are a number of ways to assign Ad units to positions of lower priority. In one example the positions are filled sequentially until a particular position has a flag indicating that no additional Ad units of a different priority are to be assigned or when there are no more Ad units of the specified priority to assign.

At step 909, if the positions within the Ad group have all been filled then the process ends; otherwise, at step 910 the next lower priority in the Ad group is specified for return to step 903. This allows the process to be executed for all priorities. For example, in the list of Table IX after position 811 has been filled the next lower priority is specified as priority 5 so that positions 822, 823 can be filled.

Table IX shows which Ad units have been assigned to the Ad group 800 of FIG. 12 when the list of Table IX is applied to the method of FIG. 9. More particularly, Ad Unit 1 has priority 10 and is assigned to position 811. Ad units 5 and 6 also have priority 10. However, there is only one position with priority 10 within the Ad group and the flag 821 indicates that the remaining Ad units 5 and 6 cannot be assigned to positions of a lower priority. Ad units 2 and 7 are assigned to positions 812 and 813. Position 813 is the last position of priority 5 being filled and the flag 823 indicates that any remaining Ad units of priority 5 can be assigned to positions with a lower priority. As such, Ad unit 4 of priority 5 is assigned to position 814. However, the flag 824 of position 814 indicates that no more positions can be filled with Ad units of priority 5. Ad unit 12 of priority 1 is then assigned to position 815 of priority 1.

As discussed above, an Ad unit template defines, among other features, which asset or assets are used in the Ad units. In some embodiments, the selection of engagement points for insertion into Ad units is based on the performance of the engagements points. More specifically, the number of times a particular engagement point is displayed and the number of times it is selected is monitored to rate the performance of the engagement points. Furthermore, in some embodiments statistical information is also collected for sets of engagement points to rate the performance of different combinations of engagement points. In some implementations, statistical information is collected for multiple Ad groups. Furthermore, in some implementations the performance of individual engagement points or combination of engagement points is evaluated in relation to tag information within Ad units of the Ad groups. One or more individual engagement points and/or a combination of engagement points are then selected to define an Ad unit template.

While specific embodiments have been described in detail in the foregoing detailed description and illustrated in the accompanying drawings, those with ordinary skill in the art will appreciate that various modifications and alternatives to those details could be developed in light of the overall teachings of the disclosure. Accordingly, the particular arrangements disclosed are meant to be illustrative only and not limiting as to the scope of the invention, which is to be given the full breadth of the appended claims and any and all equivalents thereof.

We claim:

1. A method of generating an Ad (Advertisement) group for display on a webpage having content, the method comprising:
responsive to receiving a request for displaying an advertisement on the webpage, identifying a plurality of Ad units relevant to the content of the webpage, each Ad unit comprising advertising information and having an associated category;
selecting at least some of the plurality of Ad units for the Ad group, the Ad group comprising a predefined number of positions defining a time-based sequence for display of the selected Ad units, and each position having associated with it a respective category;
for each selected Ad unit, assigning the selected Ad unit to a respective position of the positions within the Ad group, the respective category associated with the position matching the category associated with the selected Ad unit and the assigning thereby providing a respective assigned position for the selected Ad unit; and,
adding the selected Ad units to the Ad group in accordance with their respective assigned positions.

2. A method according to claim 1 comprising filling a position of the positions within the Ad group with an additional Ad unit from of the plurality of Ad units, the category associated with the position being different than the category associated with the additional Ad unit.

3. A method according to claim 2 wherein the filling a position of the positions within the Ad group with an additional Ad unit comprises:
selecting the additional Ad unit from of the plurality of Ad units;
assigning the additional Ad units to the position; and
adding the additional Ad units to the position.

4. A method according to claim 2 wherein the filling a position of the positions within the Ad group with an additional Ad unit is performed when there is an insufficient number of selected Ad units having an associated category that is the same as the category associated with the position.

5. A method according to claim 4 comprising:
determining whether a condition is satisfied prior to the filling a position of the positions within the Ad group with an additional Ad unit; and,
filling the position with the additional Ad unit only if the condition is satisfied.

6. A method according to claim 1 wherein each position within the Ad group has an associated priority and each Ad unit of the plurality of ad units has and associated priority, the method comprising filling a position of the positions within the Ad group with an additional Ad unit from of the plurality of Ad units, the priority associated with the position being different than the priority associated with the additional Ad unit.

7. A method according to claim 1 wherein each position within the Ad group has an associated priority and each Ad unit of the plurality of ad units has and associated priority, the method comprising:
for a particular priority, if the number of Ad units of the plurality of Ad units having the particular priority is greater than the number of positions within the Ad group having the particular priority filling at least one position of the positions within the Ad group having a lower priority than the particular priority.

8. A method according to claim 7 wherein each position within the Ad group has an associated flag for indicating how the positions are to be filled, the method comprising:
for each position of the at least one position using one of the flags to determine whether the position is allowed to be filled with an Ad unit having a lower priority than the priority associated with the position prior to the position being filled.

9. A method according to claim 1 wherein each Ad unit comprises a respective image and a respective image map for overlay over the respective image, the method comprising:
for each Ad unit, generating the respective image and the respective image map using advertising information on assets specific to the Ad unit and predefined rules on how to present the assets.

10. An Ad (Advertisement) server system for providing advertisements, the Ad server system comprising:
a processor;
a communications interface unit coupled to the processor; and
a memory comprising:
a database having a first plurality of Ad units each comprising advertising information and having an associated category, the database also having content information on a plurality of webpages; and
instructions executable by the processor for:
responsive to receiving through the communications interface unit a request for displaying an advertisement on a webpage of the plurality of webpages, identifying from the first plurality of Ad units a second plurality of Ad units relevant to the content of the webpage using the content information;
selecting at least some of the second plurality of Ad units for an Ad group that is to be displayed on the webpage, the Ad group comprising a predefined number of positions defining a time-based sequence for display of the selected Ad units, and each position having associated with it a respective category;
for each selected Ad unit, assigning the selected Ad unit to a respective position of the positions within the Ad group, the respective category associated with said position matching the category associated with the Ad unit and the assigning thereby providing a respective assigned position for the selected Ad unit; and,
adding the selected Ad units to the Ad group in accordance with their respective assigned positions.

11. An ad server system according to claim 10 wherein the instructions comprise additional instructions for filling a position of the positions within the Ad group with an additional Ad unit from of the second plurality of Ad units, the category associated with the position being different than the category associated with the additional Ad unit.

12. An ad server system according to claim 11 wherein the filling a position of the positions within the Ad group with an additional Ad unit is performed when there is an insufficient number of selected Ad units having an associated category that is the same as the category associated with the position.

13. An ad server system according to claim 11 wherein the instructions comprise:
first other additional instructions for determining whether a condition is satisfied prior to the filling a position of the positions within the Ad group with an additional Ad unit; and,
second other additional instructions for filling the position with the additional Ad unit only if the condition is satisfied.

14. An ad server system according to claim 10 wherein each position within the Ad group has an associated priority and each Ad unit of the second plurality of ad units has and associated priority, the instructions comprising additional instructions for filling a position of the positions within the Ad group with an additional Ad unit from of the plurality of Ad units, the priority associated with the position being different than the priority associated with the additional Ad unit.

15. An article of manufacture comprising:
a computer usable medium having computer readable program code means embodied therein for generating an Ad (Advertisement) group for display on a webpage having content, the computer readable code means in said article of manufacture comprising:
computer readable code means for:
responsive to receiving a request for displaying an advertisement on the webpage, identifying a plurality of Ad units relevant to the content of the webpage, each Ad unit comprising advertising information and having an associated category;
computer readable code means for selecting at least some of the plurality of Ad units for the Ad group, the Ad group comprising a predefined number of positions defining a time-based sequence for display of the selected Ad units, and each position having associated with it a respective category;
computer readable code means for:
for each selected Ad unit, assigning the selected Ad unit to a respective position of the positions within the Ad group, the respective category associated with the position matching the category associated with the selected Ad unit and the assigning thereby providing a respective assigned position for the selected Ad unit; and,
computer readable code means for adding the selected Ad units to the Ad group in accordance with their respective assigned positions.

16. An article of manufacture according to claim 15 comprising computer readable code means for filling a position of the positions within the Ad group with an additional Ad unit from of the plurality of Ad units, the category associated with the position being different than the category associated with the additional Ad unit.

17. An article of manufacture according to claim 16 wherein the filling a position of the positions within the Ad group with an additional Ad unit comprises:
selecting the additional Ad unit from of the plurality of Ad units;
assigning the additional Ad units to the position; and
adding the additional Ad units to the position.

18. An article of manufacture according to claim 16 wherein the filling a position of the positions within the Ad group with an additional Ad unit is performed when there is an insufficient number of selected Ad units having an associated category that is the same as the category associated with the position.

19. An article of manufacture according to claim 18 comprising:
computer readable code means for determining whether a condition is satisfied prior to the filling a position of the positions within the Ad group with an additional Ad unit; and,
computer readable code means for filling the position with the additional Ad unit only if the condition is satisfied.

20. An article of manufacture according to claim 15 wherein each position within the Ad group has an associated priority and each Ad unit of the plurality of ad units has and associated priority, the article of manufacture comprising computer readable code means for filling a position of the positions within the Ad group with an additional Ad unit from of the plurality of Ad units, the priority associated with the position being different than the priority associated with the additional Ad unit.
